(19) United States
(12) Patent Application Publication
(10) Pub. No.: US 2019/0172180 A1
(43) Pub. Date: Jun. 6, 2019

(54) APPARATUS, SYSTEM AND METHOD FOR DYNAMIC ENCODING OF SPECKLE REDUCTION COMPENSATION

(71) Applicant: Canon U.S.A., Inc., Irvine, CA (US)

(72) Inventor: Santosh Ganesan, Cambridge, MA (US)

(21) Appl. No.: 15/830,947

(22) Filed: Dec. 4, 2017

(51) Int. Cl. G06T 5/00; G06T 5/20; G06T 7/90

(52) U.S. Cl. CPC G06T 5/002; G06T 5/20; G06T 2207/10068; G06T 2207/10024; G06T 7/90

(57) ABSTRACT

An image processing device and method are provided that generates a window having a predetermined size and including a geometric center point to analyze the image data and identifies, as speckle data, one or more pixels of the image data positioned within the generated window. Corrected image data is generated by replacing the one or more pixels identified as speckle data with a replacement pixel value derived from pixels surrounding to the one or more pixels identified as speckle data in a case where the one or more pixels identified as speckle data is equal to or greater than a confidence threshold.

### BACKGROUND

### Field of Art

The present disclosure relates to image processing techniques. More specifically, the disclosure exemplifies techniques for improving image quality by identifying and filtering speckle noise from an image.

### Description of the Related Art

A myriad of imaging devices are able to capture images in many different environments for many different purposes. In doing so, the captured image may not be of optimal quality when considering the purpose for which it was captured. One field where image capture and correction is of paramount importance is the medical diagnostics field where a medical imaging device is used by one or more medical professionals to capture images from a patient with the intent to detect the presence of any abnormalities that are indicative of a medical condition for which later treatment is to be prescribed. To ensure captured images are of sufficient quality, it is known to apply some form of image processing via execution of one or more image processing algorithms. Examples of these image processing algorithms include, but are not limited to, noise reduction, color correction, brightening, etc.

Medical probes have the ability to provide images from inside the patient's body. One useful medical probe employs spectrally encoded endoscopy (“SEE”) technology, which is a miniature endoscopy technology that can conduct high-definition imaging through a sub-mm diameter probe. SEE uses wavelength to encode spatial information of a sample, thereby allowing high-resolution imaging to be conducted through small diameter endoscopic probes. SEE can be accomplished using broad bandwidth light input into one or more optical fibers. At the distal end of the fiber, a diffractive or dispersive optical component disperses the light across the sample, which returns back through the optic and then through optical fibers. Light is detected by a wavelength detecting apparatus, such as a spectrometer where each resolvable wavelength corresponds to reflectance from a different point on the sample.

Once images are captured, they are processed and stored as one or more types of image files including still images and moving images (e.g. video). These images may be selectively used by medical personnel for diagnostic or other patient-centric function. Thus, it is important that the quality of the images that are captured and subsequently output for use by others are of a sufficient quality to enable the medical personnel to understand and identify characteristics of the tissue represented in the image. Often times the images that are captured as original images are scanned or otherwise digitized or re-digitized in order to be placed in medical charts and/or used by medical personnel in diagnosing a patient.

A drawback associated with this process is the existence of artifact noise, also known as speckle or pepper noise, when the original image is scanned. Speckle or pepper noise is represented in an image by one or more pixels having high intensity values (e.g. white pixels) or low intensity (e.g. black pixels). These speckles distort the image and can cause a person viewing the image to misinterpret or misunderstand what is actually being depicted. This is particularly problematic in the medical context because it inhibits an accurate representation of the original image which may result in misdiagnosis of a patient. What is needed is a technique for de-speckle processing that can be applied on images having different distributions and that maintains contrasts and edges and which either preserves or enhances signal-to-noise ratio in the image.

### SUMMARY

Accordingly, it can be beneficial to address and/or overcome at least some of the deficiencies indicated herein above, and thus to provide an image processing algorithm that reduces speckle noise in an image.

According to at least one embodiment of the invention, an image processing device or image processing apparatus is provided and includes one or more processors and a memory storing instructions for performing image processing to correct image data by replacing one or pixels within the image data identified as being speckle data.

In one embodiment, an image processing device that processes image data comprising one or more processors; and one or more memory devices storing instructions that, when executed by the one or more processors, configures the one or more processors to generate a window having a predetermined size and including a geometric center point to analyze the image data, identify, as speckle data, one or more pixels of the image data positioned within the generated window, and generate corrected image data by replacing the one or more pixels identified as speckle data with a replacement pixel value derived from pixels surrounding to the one or more pixels identified as speckle data in a case where the one or more pixels identified as speckle data is equal to or greater than a confidence threshold.

In another embodiment, the image processing device is further configured to identify one or more pixels within the generated window as boundary pixels and exclude the boundary pixels from being used in deriving replacement pixel values to be used in replacing the one or more pixels identified as speckle data.

In another embodiment, the image processing device is further configured to maintain pixel values of the one or more pixels identified as speckle data in a case where the one or more pixel values is less than the confidence threshold.

In other embodiments, the image processing device is further configured to move the generated window over the image data and, at each position on the image data that the generated window is moved, determine if any additional pixels within the generated window should be identified as speckle data, and replace any additional pixels determined to be speckle data with the replacement pixel values derived from pixels surrounding each of the additional pixels determined to be speckle data.

In further embodiments, the image processing device is configured to identify the one or more pixels within the generated window as speckle data by generating a histogram of the image data indicating intensity values pixels that form the image data and frequency at which pixels of specific intensities occur and selecting pixel intensity values that exceed a predetermined intensity value as a global speckle threshold which, when exceeded by one or more pixels within the generated window indicates that the one or more pixels are speckle data.

In further embodiment, the image processing device is further configured to determine, using all pixel values from within the generated window, distribution data set from which the replacement pixel value is derived. In certain embodiments, the distribution data set is projected onto the distribution curve and when the one or more pixels identified as speckle data are equal to or greater than the confidence value, the replacement pixel value is derived by using a random pixel value from the distribution curve. In other embodiments, the replacement pixel value is derived by generating a mean pixel value from the distribution curve. In other embodiments, the replacement pixel value is derived by using a median pixel value from the distribution curve. In other embodiments, the distribution data set is one of (a) a normalized distribution curve, (b) a multimodal distribution curve, or (c) a skewed distribution curve.

In another embodiment, the image data is color image data and the one or more processors, for each color channel of the color image data, identify speckle data and generate corrected image data and combine generated corrected image data of each color into an color image to be displayed on a display device.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF DRAWINGS

Further objects, features and advantages of the present disclosure will become apparent from the following detailed description when taken in conjunction with the accompanying figures showing illustrative embodiments of the present disclosure.

FIG. 1 is a block diagram of an embodiment.

FIG. 2 is a flow diagram of an algorithm of an embodiment.

FIG. 3 is a exemplary image that may be processed according to an embodiment.

FIG. 4 is a histogram of the exemplary image of FIG. 3.

FIG. 5 is an exemplary window generated in accordance with an embodiment.

FIGS. 6A & B are exemplary paths along which an exemplary window may move over an image being processed according to an embodiment.

FIG. 7 is a flow diagram of an algorithm of an embodiment.

FIG. 8 illustrates an exemplary window generated in accordance with an embodiment.

FIGS. 9A & 9B illustrate a pre-processed image and an image processed according to the image processing algorithm according to the embodiment

FIG. 10A & 10B illustrate processed images according to a prior art image processing algorithm and the image processing algorithm according to the embodiment.

FIGS. 11A & 11B illustrate graphs processed images according to a prior art image processing algorithm and the image processing algorithm according to the embodiment.

FIGS. 12A & 12B illustrate processed images and associated graphs according to a prior art image processing algorithm and the image processing algorithm according to the embodiment.

FIG. 13 is a schematic of an embodiment.

FIG. 14 is a flow diagram of an algorithm of an embodiment

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

According to the present disclosure an image processing system and method are provided. The image processing system and method advantageously improves the quality of a captured image by reducing speckle noise in images that have different pixel distribution across the image. This improved image processing system executes an image processing algorithm that can operate to improve the contrast of an image having different levels of half-toning and gradients with varying pixel intensity distributions. Further improvements can be realized by the described image processing algorithm which minimizes edge blur in order to maintain edges and boundaries of objects present in the image while correcting speckle noise present therein. The image processing system effects the above improvement in image processing by executing one or more de-speckle algorithms that employ a structuring elements that traverses all pixels of an image to identify and correct pixels determined to be speckle noise. Within the structuring element, the algorithm fits values around one or more pixels determined to be speckle noise using a normalized distribution and replacing those pixel values with one or more replacement pixel values derived from the pixel values that surround the identified speckle.

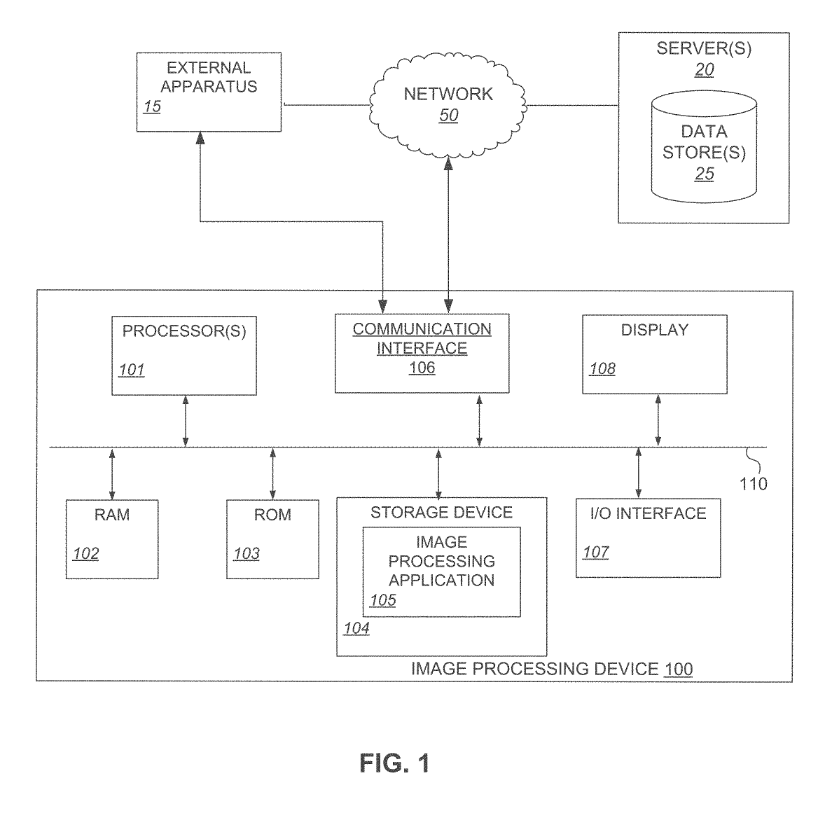

FIG. 1 illustrates an example of an image processing device 100 that includes a processing unit 101, system memory including random access memory (RAM) 102 and read only memory (ROM) 103, a storage device 104 storing various programs and data, a communication interface 106, an input/output (I/O) interface 107, and a display 108 all connected by a bus 110. As shown herein, the image processing device 100 may be connected, via a network 50, to one or more external apparatus(s) 10 and/or server(s) 20 having one or more data stores 25 that store image data that may be processed by an image processing algorithm according to the disclosed embodiments.

The image processing device 100 is an example of a computing system. The term computing system as used herein includes but is not limited to one or more software modules, one or more hardware modules, one or more firmware modules, or combinations thereof, that work together to perform operations on electronic data. The physical layout of the modules may vary. A computing system may include multiple computing devices coupled via a network. A computing system may include a single computing device where internal modules (such as a memory and processor) work together to perform operations on electronic data. Also, the term resource as used herein includes but is not limited to an object that can be processed at a computing system. A resource can be a portion of executable instructions or data.

The processing unit 101 may comprise a single central-processing unit (CPU) or a plurality of processing units. The processing unit 101 executes various processes and controls the image processing apparatus 100 in accordance with various programs stored in memory. The processing unit 101 controls reading data and control signals into or out of memory. The processing unit 101 uses the RAM 102 as a work area and executes programs stored in the ROM 103 and the Storage Device 104. In some embodiments, the processor(s) 101 include one or more processors in addition to the CPU. By way of example, the processor(s) 101 may include one or more general-purpose microprocessor(s), application-specific microprocessor(s), and/or special purpose microprocessor(s). Additionally, in some embodiments the processor(s) 101 may include one or more internal caches for data or instructions.

The processor(s) 101 provide the processing capability required to execute an operating system, application programs, and various other functions provided on the image processing device 100. The processor(s) 101 perform or cause components of the image processing device 100 to perform various operations and processes described herein, in accordance with instructions stored in one or more memory devices 103 and 104 while using the capability of the work area memory RAM 102.

The RAM 102 is used as a work area during execution of various processes, including when various programs stored in the ROM 103 and/or the Storage Device 104 are executed. The RAM 102 is used as a temporary storage area for various data. In some embodiments, the RAM 102 is used as a cache memory.

The ROM 103 stores data and programs having computer-executable instructions for execution by the processing unit 101. The ROM 103 stores programs configured to cause the image processing device 100 to execute various operations and processes. In one embodiment, the ROM 103 has stored therein an operating system that includes one or more programs and data for managing hardware and software components of the image processing apparatus 100. The ROM 103 and storage device 104 may further store one or more applications that utilize or otherwise work in conjunction with the operating system 107 in executing various operations.

The Storage Device 104 stores application data, program modules and other information. Some programs and/or program modules stored in the Storage Device 104 are configured to cause various operations and processes described herein to be executed. The Storage Device 104 may be, for example, a hard disk or other non-transitory computer-readable storage medium. The Storage Device 104 may store, for example, an operating system. As shown herein, the storage device 105 stores an image processing application 105 that can be selectively executed to perform image processing algorithms that are able to identify and correct artifact noise present within or one more images. The image processing application 105 will be further described in detail hereinafter with respect to remaining figures. It should be noted that the term application may include one or more programs comprising a set of one or more instructions and/or algorithms to be executed by one or more processing units to achieve a desired processing result.

A communication interface 106 may include hardware and software for establishing and facilitating unidirectional and/or bidirectional communication between the image processing device 100 and one or more external apparatus(s) and servers 20. The communication interface 106 may include a network interface including hardware, software, or both providing one or more interfaces for communication (such as, for example, packet-based communication) between the image processing device 100 and one or more external apparatuses and/or servers 20 on the network 50. As an example and not by way of limitation, a network interface may include a network interface card (NIC) or a network controller for communicating with an Ethernet or other wire-based network or a wireless NIC (WNIC) or wireless adapter for communicating with a wireless network, such as a WI-FI network. This disclosure contemplates any suitable network 50 and any suitable network interface for it. As an example and not by way of limitation, the image processing device 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks 110 may be wired or wireless.

The communication interface 106 may also include one or more mechanisms for establishing direct connection between an external apparatus and the image processing device 100 using one or more short distance communication protocols. One exemplary type of short distance communication protocol may include Near Field Communication (NFC) that enables bidirectional communication with a mobile computing device having NFC functionality. This may be provided by an NFC unit which includes circuitry and software that enables transmission (writes) and reception (reads) of commands and data with a non-contact type device using a short distance wireless communication technique such as NFC (Near Field Communication; ISO/IEC IS 18092). In other embodiments, the communication interface may also communicate according to the BLUETOOTH communication standard by including a transceiver capable of transmitting and receiving data via short wavelength radio waves ranging in frequency between 2.4 GHz and 2.485 GHz. In other instances, the communication interface 106 may also include an infrared (IR) unit that can emit and sense electromagnetic wavelengths of a predetermined frequency have data encoded therein. Furthermore, while not specifically shown, the short distance communication interface may also include a smart card reader, radio-frequency identification (RFID) reader, device for detecting biometric information, a keyboard, keypad, sensor(s), a combination of two or more of these, or other suitable devices.

The image processing device 100 includes an input/output (I/O) interface 107 that includes one or more ports for connecting external devices used for entering information and/or instructions as inputs for controlling one or more operations of the image processing device 100. The I/O interface 107 may, for example, include one or more input/output (I/O) port(s) including, but not limited to, a universal serial bus (USB) port, FireWire port (IEEE-1394), serial port, parallel port, HDMI port, thunderbolt port, display port and/or AC/DC power connection port. When connected to a respective port of the I/O interface 107, one or more external device(s) 108 to communicate with the image processing device 100 to one or provide input to or receive output from the image processing device 100. As an example and not by way of limitation, an I/O device may include a keyboard, keypad, microphone, monitor, mouse, speaker, still camera, stylus, tablet, touch screen, trackball, video camera, another suitable I/O device or a combination of two or more of these. An I/O device may include one or more sensors. In some embodiments, the I/O interface 904 includes one or more device or software drivers enabling the processor(s) 901 to drive one or more of these I/O devices.

The image processing device 100 may also include a display 108 that is configured to output one or more display screens generated by one or more applications executing on the image processing device 100. The display 108 may be any type of display device including but not limited to a liquid crystal display (LCD), light emitting diode (LED) display, organic light emitting diode (OLED) display and the like. Further, while the display 108 is shown as part of the image processing device 100, it should be understood that this is not required and instead, the display 108 may be selectively connected to the image processing device 100 via the I/O interface 107 such that the display 108 is external from the image processing device 100. It should also be understood that the display 108 on which output generated by the image processing device 100 is to be displayed may be present in one or more external apparatus(s)/servers connected to the image processing device 100 either via the network 50 or direct wireless communication such as WIFI direct or the like.

The system bus 110 interconnects various components of the image processing apparatus 100 thereby enabling the transmission of data and execution of various processes. The system bus 110 may include one or more types of bus structures including a memory bus or memory controller, a peripheral bus, and a local bus using any of a variety of bus architectures.

Additionally, the computing system may include other storage media, such as non-volatile flash memory, removable memory, such as a compact disk (CD), digital versatile disk (DVD), a CD-ROM, memory card, magneto-optical disk or any combination thereof. All or a portion of a computer-readable storage medium of the computing system may be in the form of one or more removable blocks, modules, or chips. The computer-readable storage medium need not be one physical memory device, but can include one or more separate memory devices.

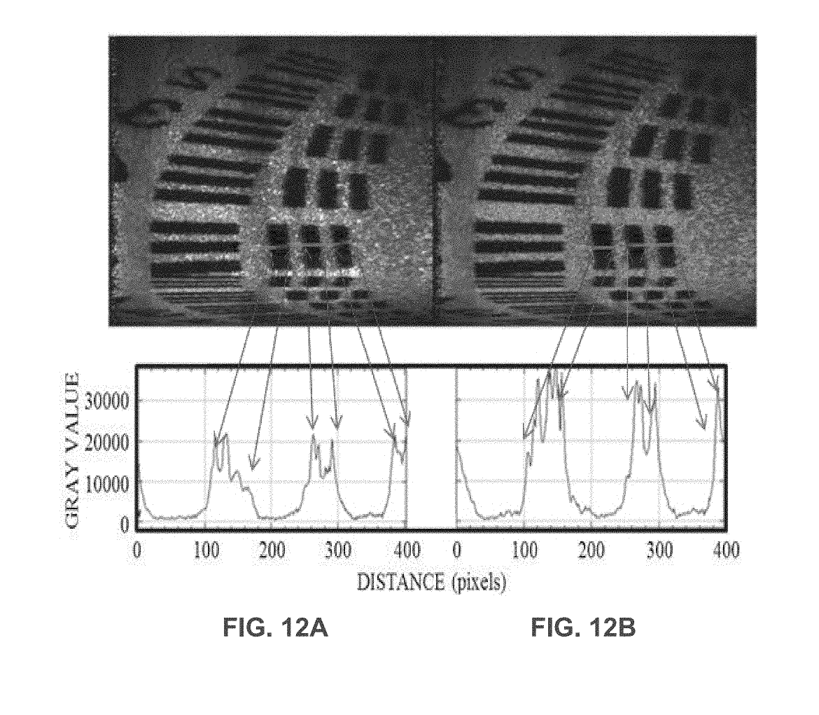

FIG. 1 further depicts the interconnection between the image processing device 100 and an external apparatus 15 and one or more servers 20 via a network 50. The external apparatus 15 may be any type of computing device including the hardware and software associated therewith and used to operate the computing device. By way of example, the external apparatus 15 may include a mobile computing device such as a smartphone or a tablet, a laptop computing device, a hybrid computing device and/or a desktop computing device. In certain embodiments, the external apparatus may be a scanning device capable of generating electronic data representing physical images scanned therein. In any of the above embodiments, the external apparatus 15 may be used to selectively provide input to the image processing device 100 for issuing control commands and/or controlling other interactions of the image processing device 100 including but not limited to directing the image processing device to execute one or more image processing algorithms 105 stored in the storage device 104. In another embodiment, the external apparatus 15 may be a source of image data that is provided, via the network 50, to the image processing device 100 which then executes and performs image processing thereon. As the source of image data, the external apparatus may directly capture the images and cause the captured images to be stored therein or merely be a repository of image data acquired via other means. One example of an external apparatus 15 for capturing image data which is processed according to the image processing application 105 is a spectrally encoded endoscope apparatus described hereinafter with respect to FIG. 12.

FIG. 1 also depicts one or more servers 20 which includes hardware, software, or both for providing the functionality of the server 20. The server 20 may include one or more data stores 25 that store one or more images therein. Thus, in certain embodiments, the server 20 may be a file server or a database server that stores image data in the data store 25. In one exemplary operation, the server 20 may receive requests from the image processing device 100, via the network 50, for image data stored in data store 25. The server 20 may retrieve the requested image data and transmit the image data back to the image processing device 100 to enable image processing thereof. In certain embodiments, the resulting image processed according to the image processing application 105 may be transmitted back to the server 20 (or the external apparatus 15) for storage. In another embodiment, the image processing device 100 may, at predetermined times or on a predetermined schedule, request sets of image data from one of the external apparatus 15 and/or server 20 such that the image processing algorithm 105 may be executed on a plurality of images.

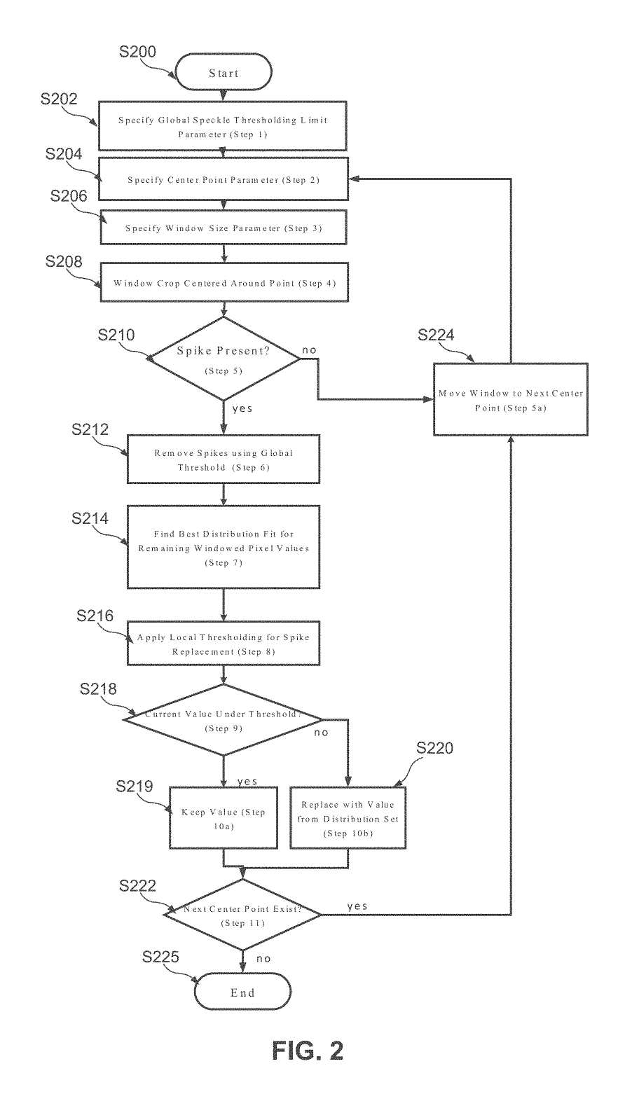

FIG. 2 illustrates an exemplary algorithm for processing an image and which may be embodied as the image processing application 105 discussed above. The algorithm provides a functional improvement to the image processing device in that the image output thereby has a higher quality and allows users who review the image to better understand what is captured thereby. The algorithm described in FIG. 2 is advantageously applicable to image data that has multiple distributions and tones such that contrast and edges may be maintained (or otherwise improved) while preserving or enhancing signal-to-noise ration within the image. Furthermore, the algorithm described herein provides an improvement in that the algorithm does not require an assumption that the pixel distribution within the image data being processed is a normal distribution which assumes certain constraints which, in the medical imaging context, are not necessarily accurate such as (a) a strong tendency for the data to take on a central value; (b) equal likelihood of positive and negative deviations from the central value and (c) the frequency of deviations diminishes rapidly as distance from the central value increases. Thus, the image processing algorithm described herein improves the image quality of the images processed using a dynamically definable structuring element, the size of which is dependent on speckle size, around a given center pixel location. The image processing application 105 generates the structuring element, also referred to herein as a structuring window, having a defined height and width in pixels and processes the image by moving the structuring elements over the entirety of the image. In moving the structuring element over the image, the image processing application 105 identifies one or more pixels within a particular instance of the structuring element as speckle data and analyzes other pixels within the same instance of the structuring element and which surround the one or more pixels identified as speckle data to determine (a) if the pixels indicated as speckle data should be replaced and (b) a color value (either grayscale value or RGB value) of the replacement pixel. The application advantageously determines whether or not the one or more pixels identified should be replaced by determining a confidence value indicative of replacement. The confidence value is indicative of whether or not a replacement pixel value would improve the overall image quality after image processing has been completed.

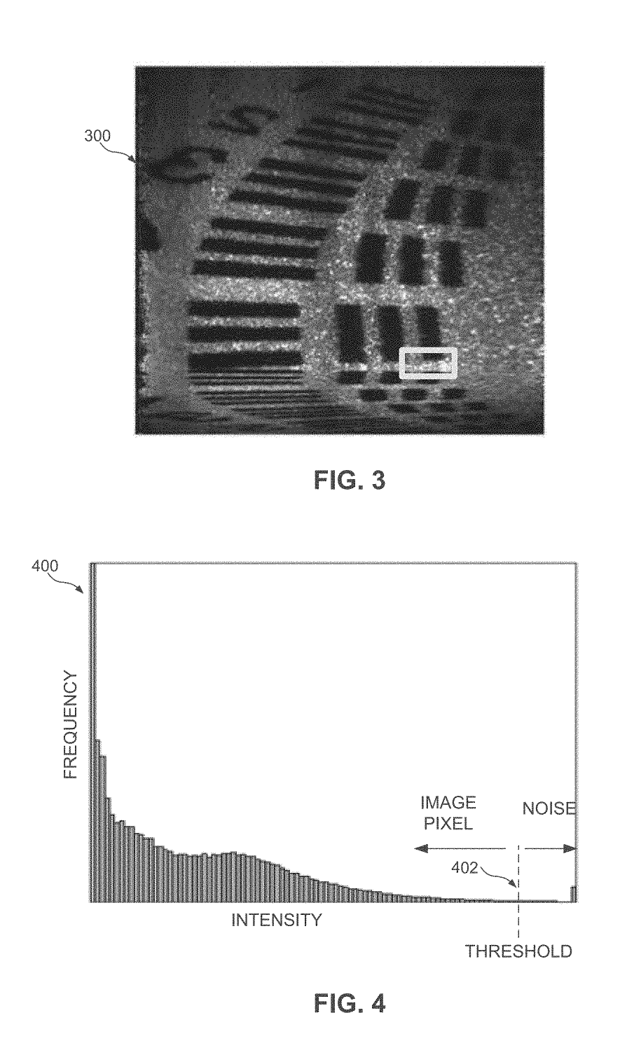

In exemplary operation, the image processing application 105 includes at least one or more of the instructions illustrated in FIG. 2 and will be described with reference to an input image 300 in FIG. 3 that is to be processed by the image processing application 105. Operation begins at step S200 and proceeds to S202 whereby a global speckle threshold value is set. In one embodiment, the global speckle threshold value is set by a user via a user interface (UI) display generated by the image processing application 105 and displayed on display 108 or provided to a display of the external apparatus 15. This may occur using one of user fillable fields within a UI or user selectable image elements.

An exemplary manner for identifying and setting the global speckle threshold value is shown with respect to FIG. 4. Once input image 300 is received and selected by a user for image processing, the image processing algorithm can selectively analyze the pixel data of the input image 300 and generate a histogram of the image indicating the intensity values of the various pixels that form the image and the frequency at which pixels of specific intensities occur. The histogram may be displayed to a user in a UI on display 108 and include a selector 402 indicated by the dotted line in FIG. 4. The selector 402 is an image element that is movable over the x-axis in the histogram 400 that allows the user to set the global speckle threshold value which is then used to identify pixels throughout the image as speckles and determine if removal and correction thereof would improve the output image quality. Pixels that are to be indicated as speckle have high intensities that appear as bright white such as those shown within region 302 in FIG. 3.Alternatively, pixels identified as speckle may also have very low intensities and appear and dark black. The operation of the image processing application 105 is being described with respect to identification and correction of pixel values having high intensity values which require that step S202 identify and set a maximum global threshold value. However, the image processing application 105 may operate to identify and correct pixel data indicated to very low intensities by identifying a global minimum threshold that will be able to identify pixels as low intensity speckle and determine if they should be corrected (e.g. black speckle). The global speckle threshold value can be used to identify the size of the speckle within the input image 300.

In another embodiment, the global speckle threshold set in step S202 may be dynamically set based on previously set global speckle threshold values. In this manner, the image processing application 105 analyzes the entirety of the input image 300 and compares image characteristics of the input image 300 with a set of image characteristics determined from previously analyzed input images to determine and set the global speckle threshold value automatically. In another embodiment, the image processing application 105 generates the histogram 400 to present to a user in the UI with the selector 402 positioned along the x-axis thereof at a position that has been determined dynamically based on prior image processing operations thereby enabling the user to selectively refine the selection of the global speckle threshold value based on user experience.

In step S204, a geometric center for a structuring element is set and in step S206, the image processing application determines and sets a size of the structuring element that will be used in analyzing the input image 300 to identify and correct one or more pixel values from within the structuring element determined to be speckle based on the global speckle threshold value set in step S202. The size of the structuring element is set based on the determination of the geometric center point set in step S204. The structuring element has a height and width, in pixels, sufficient to cover area if the input image that includes one or more pixels indicated, based on the global speckle threshold value, to be speckle data and pixels that are not speckle and from which distribution data may be obtained and used, as described below, to correct the value of the one or more pixels identified as speckle data. It should be noted that the area within a particular structuring window can include more than one instance of speckle data and that the more than once instances of speckle data can be identified and corrected using pixel values surrounding the speckle data. Upon setting of the geometric center point, the image processing application 105 generates, in step S206, a structuring window for movement over the input image 300.

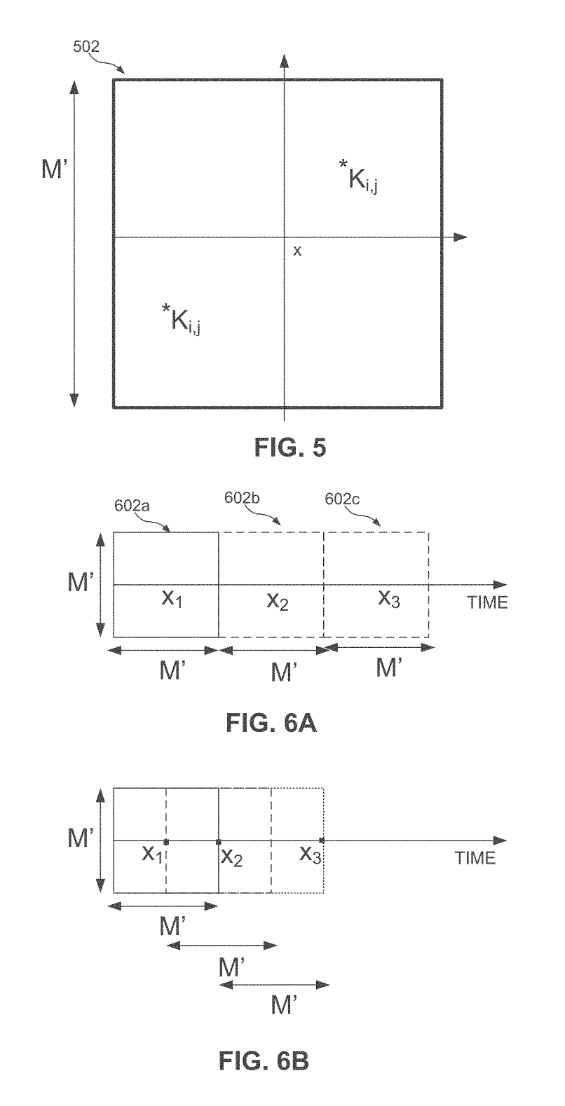

An exemplary structuring window 502 generated in step S206 and defined by the parameters set in S202 and S204, is shown in FIG. 5. The structuring window 502 has a geometric center point “x” as determined in step S204 and has a height and width of M′ number of pixels. In this exemplary structuring window 502, based on the set global speckle threshold values, pixels within the window 502 labeled K_{i,j}, where i and j are one dimensional index values identified as speckle data. The strutting window 502 is a sliding window that is moved over the entire area of the input image and processing on the pixels within the boundary of the window is repeatedly performed. An example of the sliding operation of the structuring window is shown in FIG. 6A. A window 602a at a first time and having center point x₁ is generated and used in speckle identification and correction as will be discussed hereinbelow is performed. Thereafter the image processing application 105 moves the window M′ number of pixels from the center point x₁ and sets a subsequent center point x₂ for a subsequent window position 602b at a second time. Once processing within window 602b is completed, the sliding process is performed such that a subsequent center point x₃ is set to be M′ pixels from x₂. This process is completed in the horizontal direction when there are no more pixels available. The above described movement of the window is described with respect to the horizontal directional movement of the window. However, similar movement principles may be applied in the vertical direction whereby the application 105 may move the window in the vertical direction M′ number of pixels from any of the previously identified center points xₙ and perform the same processing to identify and correct the speckle value. In one embodiment, the application 105 stores the initial center point set x₁ and, at the completion of all horizontal movement of the window 602, returns back to the initial center point and sets, as a new center point x, a pixel that is M′ pixels from x1 in the vertical direction. In another embodiment, assuming that x₃ is the final center point in the horizontal direction of the input image, the application 105 sets the new center point as M′ pixels in the vertical direction from x₃. In this embodiment, after setting a new center point in the vertical direction, the next horizontal movement of the window will occur in the negative direction.

The window generation and movement described above with respect to FIG. 6A is a non-overlapping window arrangement that can maximize the identification and correction of speckle data while minimizing the computational cost of doing so. However, for a more robust, but computationally more expensive iteration, the application may use an overlapping sliding window movement as shown in FIG. 6B. The setting of center points and movement of the window is the same as described above with the following exception. Instead of setting each subsequent center point at M′ pixels from the previously set center point, to achieve an overlapping sliding window, each subsequent center point is set at ½ M′ pixels. This value is illustrated for purpose of example only and any number between 0 and 1 pixel may be used to identify the amount of overlap between each adjacently moving structuring windows.

Turning back to FIG. 2, the defined structuring window is positioned over an initial position of the input image to analyze each pixel within the structuring window to determine if one or more pixels in the window are speckle data in step S208. In other words, the image processing application 105 analyzes the pixels in the window to identify if there is an intensity spike that is present based on the global speckle threshold value previously set. Step S208 is performed by comparing the pixels in the window to each other to determine if the difference in pixel values exceeds the global speckle threshold value. If the result of the determination indicates that one or more pixels in the structuring window are speckle data (YES in S208), the application 105 then marks, as K, a position of the one or more pixels within the structuring window speckle data using the one dimensional values i and j (as shown in FIG. 5) in step S210. The values for each K_{i,j} identified as speckle may be temporarily stored in memory and used in the next processing steps when analyzing the surrounding pixels to determine the corrected pixel value that will replace a current pixel value at a particular K_{i,j}.

Upon identifying that one or more pixels in the structuring window are speckle due to an intensity of the one or more pixels exceeding the intensity value of the global speckle threshold value, the image processing application 105 finds a best distribution fit for the remaining pixel values within the particular structuring window as shown in step S212. In step S212, the application 105 uses at least one distribution determination algorithm in determining a best fit pixel value that may be used to replace the one or more pixel values identified as speckle data. The at least one distribution determination algorithm includes one or more of (a) a normal distribution; (b) a multimodal distribution and (c) a skewed distribution.

The application 105 calculates the normal distribution of pixel values within the structuring window which presumes that a set of pixel values within the particular structuring window tends to lie around a central data value without any positive or negative preference (e.g. a bell curve). A standard deviation is calculated and measure how spread out the pixel value data is away from the center, generally follows a consistent pattern, where about 66% of values are within 1 standard deviation of the mean, 95% of values are 2 standard deviations from the mean, and 99.7% of values are 3 standard deviations from the mean. This calculation is performed by the application determining a mean pixel value (m) by Σ X/N where X is the data value (e.g. pixel value) and N is the number of data points (e.g. number of pixels within the structuring window. Thereafter a standard deviation is calculated as

$$s = \sqrt{\frac{\sum {( X - m )}^{2}}{( N - 1 )}} ,$$

The application 105 may calculate a multimodal distribution when the pixel values within the structuring window indicate two or more different peaks centered around two or more central values, b. The multimodal distribution may be computed according to the following equation:

$$y = {\sum }_{i = 1}^{n} {a}_{i} {e}^{[ - {( \frac{x - {b}_{i}}{{c}_{i}} )}^{2} ]}$$

where x is the data value, a is the amplitude, b is the center value of the curve, c is the peak width, and n is the number of peaks. The standard deviation for each peak is calculated with respect to each separate center value.

The image processing application 105 calculates a skewed distribution which indicates a bias around a particular central value m. The Fisher Pearson coefficient attempts to quantify the degree of skewness with respect to the current data value observed, and the mean and the standard deviation of the data set. For a skewed, non-normal distribution, the Fisher Pearson coefficient is calculated according to the following equation:

$$δ = \sqrt{\frac{N ( N - 1 )}{N - 1} \frac{{\sum }_{i = 1}^{N} ( {X}_{i} - m ) 3 \text{/} N}{{s}^{3}}}$$

where Xᵢ is the data value, N is the number of data points, m is the mean, and s is the standard deviation. For this case, the standard deviation is the square root of the variance:

$${s}^{2} = \frac{1}{N - 1} \sum {( {X}_{i} - m )}^{2}$$

The normal distribution has a skewness of zero. Negative values indicate left skewed distribution and positive values indicate right skewed distribution.

At the completion of the best fit determination in step S212, the image processing application 105 performs a local thresholding operation in step S214 to inform whether or not the one or more pixels identified as speckle data should be replaced with a value from one of the distribution sets determined in step S212. The local thresholding operation is an efficacy determination with respect to the best fit approximation and assigns a confidence value to the proposed pixel data values within the structuring window that may be used to replace the pixel values identified as speckle data. The confidence interval may be calculated in step S214 using a central limit theorem

$$m \frac{+}{-} \frac{( 1 - C )}{2} \frac{s}{\sqrt{N}}$$

Given a population with known sample mean (m) and standard deviation (s), the confidence interval is ±(1-C)/2 for a normal distribution and skewed distribution with large sample size. In the above C is the user defined Confidence Interval which is also known as the local threshold value in step S214. In certain embodiments, the confidence interval is preset by the user and is determined by how well the sample pixel population estimates a normal non speckled space. In one embodiment, the confidence value may be predetermined using characteristic information indicative of known imaging characteristics of the surface being imaged in combination with known image generating characteristics of the image capturing apparatus and its effect on common surfaces of interest, such as bone, tissue, cartilage, etc. In one embodiment, a calibration map that is specific to a particular surface of interest can be generated to produce a filter that may be selectable as the confidence interval for us in step S214.

In step S216, the application 105 compares a current pixel value of the one or more pixels identified as speckle data are less than the local threshold value. If the determination in step S216 indicates that the one or more pixel values are below the threshold (YES in S216), the application determines that the one or more pixel values should not be replaced in step S218 and the pixel value is kept. If the determination in step S216 determines that the one or more pixel values exceed the threshold, the application 105 determines that the one or more pixel values should be replaced in step S219 with a value derived from the distribution set based on the confidence value discussed above.

After pixel replacement determination is completed for all positions of K_{i,j} within a particular structuring window, the application determines, in step S220, whether a subsequent center point exists to which a subsequent window may be centered around. If a window can be moved in in either the horizontal or vertical direction at least M′ pixels from the current center point, then the determination in S220 is positive and the structuring window is moved to the next center point as shown in step S224. It should also be noted that in step S210, if the application determines that no spikes indicative of speckle are present within the particular window, the application also proceeds to step S224 to move the window to the next center point. If not further center point can be detected or set, the application 105 ends processing and generates an output image that modifies the original input image with pixel values replaced in accordance with the above instructions.

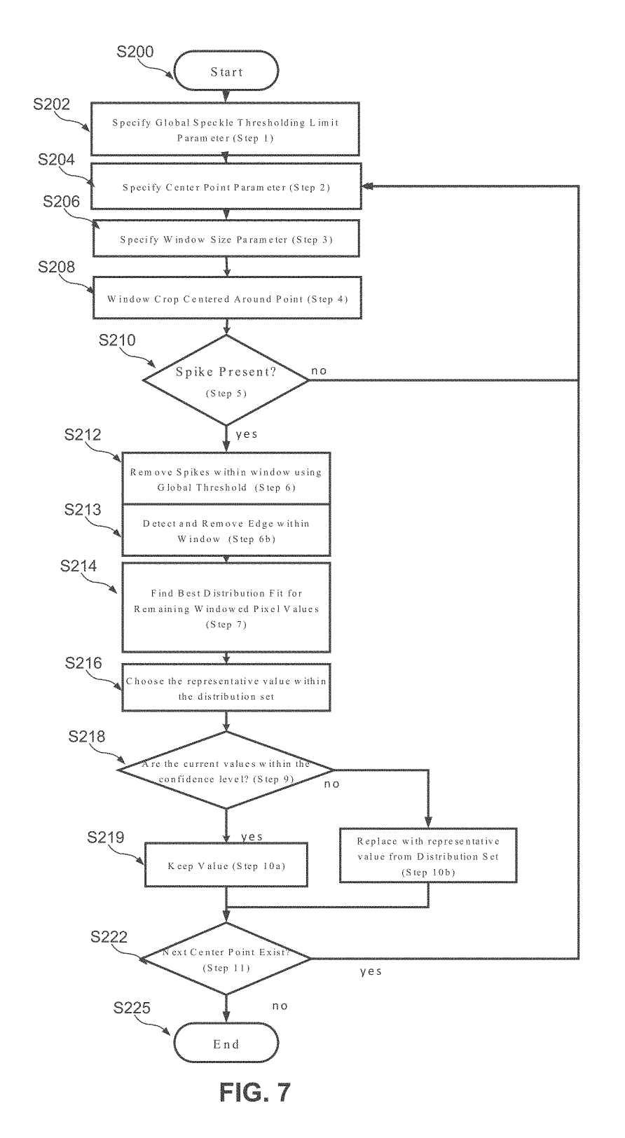

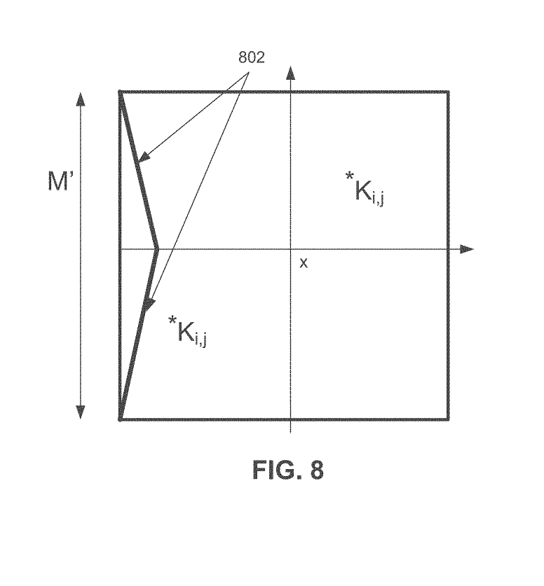

In another embodiment, the image processing application 105, when determining whether or not to replace one or more pixel values identified as speckle data, detects and removes from the best fit distribution calculation in step SS214 in FIG. 3, areas within the structuring window that are defined edges which are defined shapes having high or low pixel intensity values and should remain as such. The algorithm for implementing this embodiment is shown FIG. 7. FIG. 7 includes the same steps as discussed above with respect to FIG. 2 with the additional step S213. While shown in sequence as being performed after S212, this is not necessarily the required order of operations. The detection and removal of one or more pixels identified as edge pixels 802 may occur at any time after the structuring window is generated and positioned over a particular position in the image data. An example of a structuring window having one or more pixels indicative of edges is shown in FIG. 8. The set of pixels indicative of edges 802 is illustrated as a triangle shape for ease of understanding but it should be understood that, depending on the nature of the input image, the edge may not have a known geometric shape.

The edge detection processing performed in step S213 in FIG. 7 includes execution of a Canny Filter. A 2 Dimensional N×N Gaussian Filter is used to reduce noise and for a given function ρ(x,y), where x and y represent the two directions,

$$ρ ( x , y ) = \frac{1}{2 π {s}^{2}} * ɛ - \frac{{x}^{2} + {y}^{2}}{2 {s}^{2}}$$

Next, the intensity gradient within the structural element in both the x and y directions are calculated. The Gradient direction is always perpendicular to edges.

$$Edge\_Gradient ( G ) = \sqrt{{G}_{z}^{2} + {G}_{y}^{2}}$$

$$Angle ( θ ) = {tan}^{- 1} ( \frac{{G}_{y}}{{G}_{x}} )$$

A non-maximum suppression application is applied to check if at every pixel, there exists a local maximum in its neighborhood that is in the direction against its gradient. If this standard is upheld, then the pixel is classified as an edge. Finally Hysteresis thresholding is applied in order to prevent the breakup of an edge contour caused by the output of the non-maximum suppression to fluctuate above and below a pre-determined threshold. If a single threshold, T1 is applied with respect to the gradient of an image, and an edge has an average gradient equal to T1, then due to noise, there will be instances where the edge dips below the threshold. There will be equal instances where the edge will extend above the threshold making an edge look like a dashed line. To avoid this, hysteresis uses two thresholds, a high and a low. Any pixel in the image that has a value greater than T1 is presumed to be an edge pixel, and is marked as such immediately. Then, any pixels that are connected to this edge pixel and that have a value greater than T2 are also selected as edge pixels. Once the edge pixels are identified, they are removed from being used in the best fit distribution calculation. By removing edge pixels from being included in the best fit calculation, the overall output image quality is improved because any of the one or more pixels identified as speckle and which are replaced due to exceeding the local threshold value, is selected from a set of background pixels that surround the speckle data and not from edge pixels that might cause the replacement pixel value to be darker or brighter than it should be thereby generating a smoother, clearer output image.

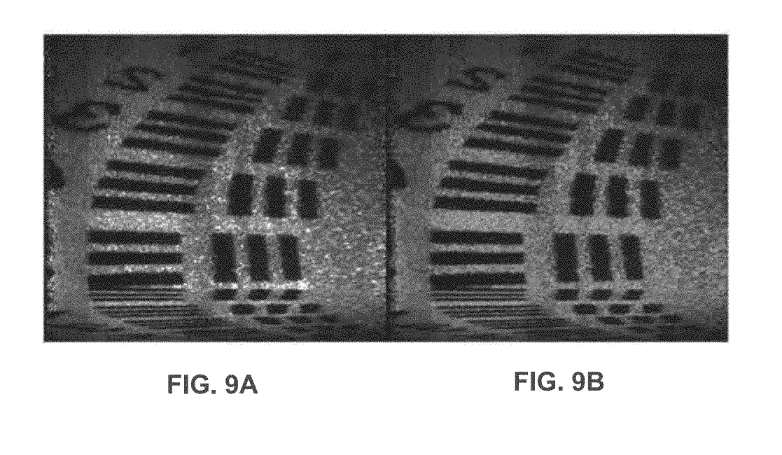

FIGS. 9A & 9B illustrate the comparison of an input image 300 shown in FIG. 9A and the processed image 900 processed using the image processing application 105 shown in FIG. 9B. To generate the output processed image 900, a structuring element with outer square dimension M′=30 pixels was used as a sliding window. The definition of the window size was selected to ensure that edge detection could properly be performed. Edge pixels were removed (step S213) for the local thresholding calculation, the data was dynamically fit onto a normalized distribution curve (step S214), and spikes were replaced with pixel values picked within the 90% confidence interval of the curve (step S220). In one embodiment, the application 105 selects replacement pixel values randomly from amongst those pixel values surrounding the spikes within the structuring window that are within the 90% confidence interval of the best fit distribution. In another embodiment, the application 105 selects replacement pixel values that is one of the mean or median values of the 90% confidence interval of the best fit distribution. For this exemplary output image confidence interval C is a user defined parameter and 90% is chosen for this example. The confidence interval is used in order to quantify how likely the replacement pixel value is a reasonable representation of the background. If a confidence interval is too low, then you are choosing a value with a low confidence threshold. In general, you would do this when the pixel values around the speckle represent a complicated or uncommon scene that the algorithm is may have difficulty fitting onto a distribution. If confidence interval is set higher, then a determination is made that the background scene around the replacement value can be approximately fit onto the distribution. In this scenario, the background scene is more common and representative. The danger in picking too high a confidence value in all instances is that if the background scene is does not fit reasonably well to a distribution, then there will be no candidate pixel values that meet the threshold criteria needed for replacement.

As can be seen, the original input image 300 in FIG. 9A includes substantial number of pixels having a strong intensity and thus appearing bright white. These are the speckles that were removed from the image using the image processing algorithm discussed above. The result is a smoother image that provides the viewer with a improved view of the surface captured by the image processing apparatus. This is particularly important in the medical imaging field concerning diagnostics. This smoother output image allows a user to better understand the characteristics of the surface being captured which allows for improved ability to inspect for clinically significant defects. The image processing application is particularly advantageous in that is can correct and smooth images having a broad array of halftone and gradients with varying pixel intensities throughout the overall image being processed.

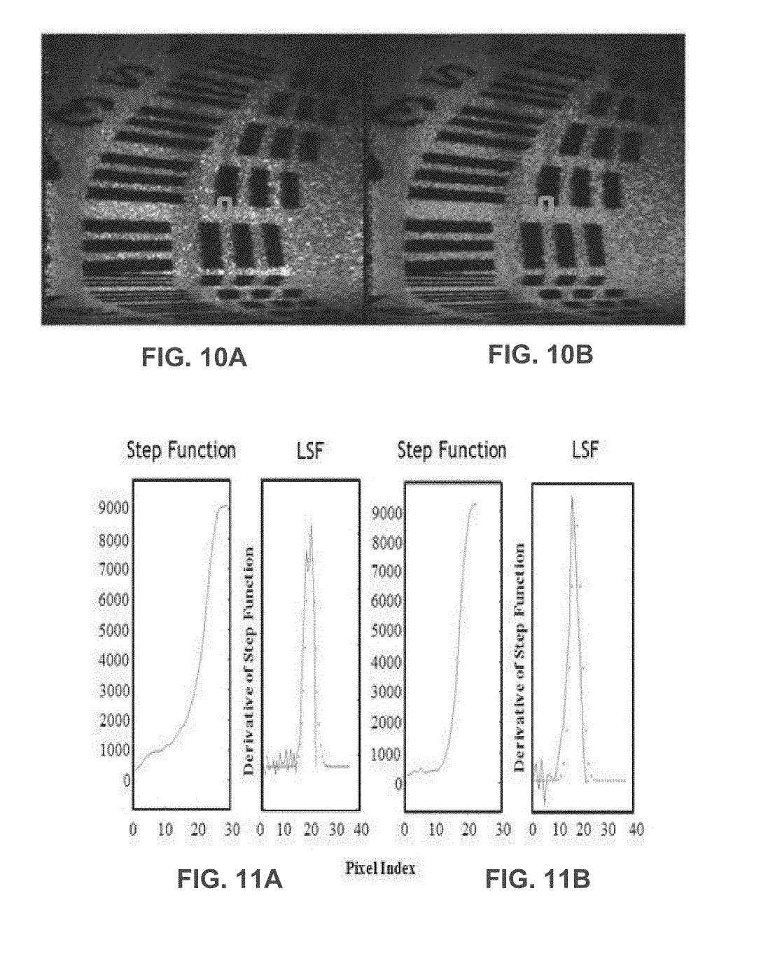

FIG. 10A illustrates an image processed according to a conventional de-speckle algorithm and FIG. 10B illustrates an image output in accordance with an embodiment of the above described image processing application 105. The image illustrated in FIG. 10A was processed to identify and remove speckle by eroding the image using an annular window structuring element. The conventional structuring element used to produce the image in FIG. 10A allows each pixel to be evaluated by value and location relative to other pixels after being eroded. For dark speckles, if the original pixel has a larger value (lighter color) than the value of the eroded image, the original pixel value is used as the pixel value in the output image. If the original value is lower (darker color) than the value of the eroded image, then the pixel value of the eroded image is used as the output pixel value. The opposite holds for white speckles. The structuring element, used in the conventional algorithm has an outer boundary of M pixels and an inner boundary of N pixels such that pixels in the domain between the inner boundary of M and outer boundary of N are evaluated and replaced, For example, the conventional de-speckle algorithm determines if the darkest pixel in the domain has a color lighter than a color at the geometric center x (which is the center for M and. N windows) then the original pixel in the domain is replaced with the lighter color pixel. Conversely, if the darkest color pixel is darker than the original color at x, the pixel will not he replaced. The conventional algorithm may, for example, identify a potential speckle is an actual speckle according to the equation f_{i,j}-Bₓ<Γ where f_{i,j} is the actual gray level of a pixel, and Γ is a pre-determined threshold of gray level 50000.

A comparison of the improved quality of the image in FIG. 10B which is output according to the image processing algorithm 105 can be represented by examining edge quality of a segment in the sample image (FIG. 10A) compared with the image output by the image processing application 105 discussed above. Although, edge enhancement is not the primary focus of this proposed algorithm, an effective image processing method requires preservation of edges. This comparison is represented graphically in FIGS. 11A which corresponds to FIG. 10A and FIGS. 11B which corresponds to FIG. 10B. Within the windows shown in each of the images in FIG. 10A and 10B, horizontal binning is performed along an edge across a range of pixel indices in order to obtain a step function. The slope of the derivative of this step function highlights the edge within the window of interest. The sharpness of the edge is proportional to the sharpness of the peak. In this particular segment, the edge within the window of FIG. 10B is shown to be slightly sharper with a Gaussian estimate Full width half maximum(FWHM) of 5.61 versus the image in FIG. 10A which has a FWHM 6.06.

A further metric used to show the improved image output by the image processing application described herein is determined by the differences in contrast between the two images. FIG. 12A illustrates the same image discussed above in FIG. 10A and FIG. 12B illustrates the same image output according the image processing algorithm 105. In both the images in FIGS. 12A and 12B a marker is illustrating highlight a particular section of the processed image against which a grayscale analysis can be performed to detect contrast. As can be seen in the graph disposed below the image in FIG. 12B, there is a higher ratio of gray level versus the baseline relative to the image in FIG. 12B without any visual loss in edge distinction. This indicates that by using the best fit detection and replacement described herein, the pixel value selected from the distribution set resulted in a higher quality image as compared to the replacement performed by the conventional de-speckle algorithm.

The above described image processing application may be used to process images captured by an image capturing apparatus. An exemplary embodiment of an image capturing apparatus that captures a series of moving images from which individual image frame data may be extracted and processed according to the above image processing applications is shown in FIG. 12. The image processing apparatus may include any probe or apparatus that is selectively inserted into a body of a subject (e.g. human or animal) in order to obtain an image of a target area within the body of a subject. In one exemplary embodiment, the image processing apparatus may be a SEE probe system 1300. This exemplary SEE probe system 1300 may include a light source 1310, a probe 1320, a spectrometer 1342, and an image processor 1350. In another embodiment, the SEE probe system may include a display device for selectively displaying images captured via the probe 1320 and processed by the image processor 1350. In another embodiment, the SEE probe system may include one or more storage devices on which captured image data may be stored.

In this embodiment, broadband light from the light source 1310 is coupled into a light guiding component which may be an illumination optical fiber 1312. The broadband light has sufficient bandwidth to allow for spatial resolution along the spectrally dispersed dimension. In some embodiments, the broadband light is a broadband visible light source that includes a blue band of light (including wavelength λ_{B1} to λ_{BN}), a green band of light (λ_{G1} to λ_{GN}), and a red band of light (λ_{R1} to λ_{RN}). For example, the blue band contains 400-500 nm light, the green band contains 500-600 nm light, and the red band contains 600-800 nm. In other embodiments, the wavelengths of the broadband light are optimized for identifying specific features such as blood, tissue, etc., and may extend into the near-IR region, for example 1200 nm. In an embodiment, each wavelength band may have wavelength range that is greater than 30 nm. An embodiment may include at least three bands which would allow the SEE to produce color images. More bands may be used to acquire additional information.

The broadband light source 1310 may include a plurality of light sources or may be a single light source. The broadband light source 110 may include one or more of a laser, an OLED, a LED, a halogen lamp, an incandescent lamp, supercontinuum light source pumped by a laser, and/or a fluorescent lamp. The broadband light source 1310 may be any light source that provides light which can then be split up into at least three bands in which each band is further dispersed to provide light which is then used for spectral encoding of spatial information. The broadband light source 1310 may be fiber coupled or may be free space coupled to another component of the SEE probe system 1300.

A light guiding component may be an illumination fiber 1312 or some other optical waveguide which is connected to an SEE probe 1320. The illumination fiber 1312 may be a single-mode fiber, multi-mode fiber or double clad fiber. Preferably, a single fiber is used as the illumination fiber 1312. The probe 1320 or parts thereof may be rotated or oscillated as indicated by the arrow. For example, the illumination fiber and illumination optics may be rotated via a rotary junction.

After illumination of the diffracted light (e.g., red, green, and blue light) on the sample 1330 (e.g., a tissue or in vivo sample), light is reflected, scattered, photoluminescence by the sample 1330. This light is collected by the detection fiber 1340 which may or may not pass through a grating. Detection fiber(s) 1340 used to collect the light may be attached on or near the side surface of the lens of the probe 1320. The detection fiber 1340 may optionally be rotated along with the illumination optics or may be stationary. If rotated, the detection fiber 1340 may be connected, via a rotary junction, to a second non-rotating detection fiber.

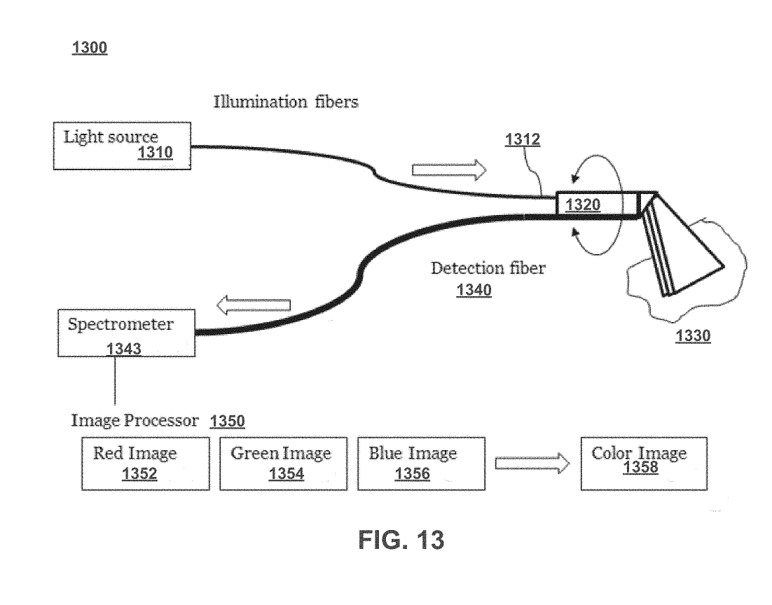

As shown in FIG. 13, the collected light is delivered to the spectrometer 1342 via the detection fiber 1340. The spectrometer 1342 obtains 1D spectral data for the 3 wavelength bands (e.g., blue, green, and red light). This 1D spectral data corresponds to information from the three illumination lines (RGB) on sample 1330.

The probe 1320 of FIG. 13 is rotated around the optical axis by a motor as indicated by the arrow such that illumination light lines scan the sample, and 2D data (wavelength and time) may be obtained by the spectrometer 1342. The motor can be, for example, a Galvano motor, stepping motor, a piezo-electric motor, or a DC motor. A rotary junction may be used for rotation of the probe. For example, by rotating the spectrally encoded lines in the direction of the arrow, a circular region can be imaged. This circular region can be located approximately perpendicular to the SEE probe, and therefore, the exemplary SEE probe shown in FIG. 1 can conduct forward-view imaging if m and G are chosen so that light is diffracted at angle of θ_{d}=θᵢ. Alternatively, the probe 1320 may be oscillated to provide similar 2D data. At the spectrometer 1342, the wavelength of the collected light can be read out, which can be used to generate a line image of the sample.

After the spectrometer and one or more detectors detects the collected light, an image processor 1350 generates three 2D images (1352, 1354, 1356) for red, green, and blue from the data. In other embodiments, two, four, or more 2D images are formed using a probe with appropriate overlapping orders of diffracted light.

The image processor 1350 builds a 2D color image 1358 from the 3 substantially monochromatic images: a red image 1352; a green image 1354, and a blue image 1356. This color image 1358 may be created so as to simulate a true color image or may be adjusted to highlight differences in, for example, tissue type. In some embodiments, a two or four tone image may be built instead of or in addition to the color image 1358. The image processor 1350 further executes one or more image processing algorithms on the generated color image 1358 that have been discussed throughout the present disclosure.

In one embodiment, the image processor 1350 includes one or more computer unit(s) and one or more display unit(s) which may be connected to the image processor 1350 via a high definition multimedia interface (HDMI). The description of an HDMI connection is provided for exemplary purposes only and any other connection interface able to output high definition video image data maybe be used.

In one embodiment, the image processor 1350 may include hardware components, software components and/or a combination thereof. The image processor may include one or more processor(s) that execute one or more stored control algorithms. The one or more processors that comprise the image processor 1350 may be similar to those discussed above with the processing unit 101 in FIG. 1. Additionally, the image processor 1350, while described separately from the image processing device 100 of FIG. 1 may further include the components described herein with respect tothe image processor 1350 such that captured images may be stored in storage device 104 of FIG. 1 for processing according to the image processing algorithm 105 which includes one or more of the algorithms described throughout the present disclosure.

The image processor 1350 may execute instructions to perform one or more functions for operating the image capture apparatus (a) automatically in response to trigger events, (b) in response to user input or (c) at a predetermined time. The image processor 1350 may include an I/O interface in which commands are received via one or more an included or separately attached touch panel screen, keyboard, mouse, joy-stick, ball controller, and/or foot pedal. A user/operator may cause a command to be initiated so as to observe or gather information about a subject which may be inside a human body through an exemplary front-view SEE probe using the image processor 1350. Other exemplar devices connectable through the I/O interface include but is not limited to a printing device, a touch screen, a light pen, an optical storage device, a scanner, a microphone, a camera, a drive. In another embodiment where the image processor 1350 is embodied as part of image processing device 100 in FIG. 1, the I/O interface 107 shown in FIG. 1 may present the point at which external control devices such as those discussed above may be coupled to the image processor 1350.

According to another embodiment, a detector interface is provided which may include a detection system such as the spectrometer 1342, components within the spectrometer, for example a photomultiplier tube (PMT), a photodiode, an avalanche photodiode detector (APD), a charge-coupled device (CCD), multi-pixel photon counters (MPPC), or other and also components that provide information about the state of the probe such as a rotary encoder, motor drive voltage, thermocouple, etc. Also, the function of detector may be realized by computer executable instructions (e.g., one or more programs).

In an exemplary operation, the user may place the exemplary SEE probe into a sheath, and then may insert such arrangement/configuration into a body of a subject at a predetermined position thereof. The sheath alone may be inserted into the human body in advance, and it is possible to insert the SEE probe into the sheath after sheath insertion. The exemplary probe may be used to observe inside a human body and works as endoscope such as arthroscopy, bronchoscope, sinuscope, vascular endoscope and so on. The images captured during the exemplary operation may be stored in or more data formats including but not limited to video data or still image data. The image processing algorithms described herein may be applied to any image data captured by the image capture device such that artifact noise such as speckle noise can be corrected thereby enhancing the quality of the image by making the speckle noise less pronounced within the image data.

The above described speckle correction algorithm may also be applicable to images captured by an image capture apparatus such as the one described in FIG. 13. In this embodiment, the speckle correction can be applied in real time as the images being captured by the probe are being processed for output in color (e.g. RGB) to a display. In exemplary operation, a process for generating color images representing an imaging surface captured by an image capture apparatus such as the SEE probe system includes obtaining raw (e.g. red channel data, green channel data and blue channel data all stitched together) spectrum data having a predetermined bit size and captured in an array of a predetermined size. The array includes a predetermined number of lines scanned by the probe where each line has a predetermined number of pixels and including a predetermined number of sensors used in capturing the spectral information of each pixel and line. In one embodiment, the array may be one having a dimension of 1000×2048×2, where there are 1000 lines each having 2048 pixels and the information is being captured by 2 sensors. In one embodiment, the two sensors include a first sensor for capturing light wavelength in the red and green band and the second sensor capturing light wavelength in the blue band. This sensor array is described for purposes of example only and any number of sensors can be used. Moreover, it is possible to have dedicated sensor to capture each of the red, green and blue bands. Further it is also possible for there to be more than one sensor used to capture the same spectral band (e.g. 2 sensors to capture wavelengths in the blue spectrum). Upon capturing the raw data, spectrum compensation on the obtained raw data can be performed. This may include, but is not limited to, correction algorithms that correct for spectral variation of the source power and diffraction efficiency. Scale correction may be performed so that the spectrums are of substantially the same size by adjusting the horizontal dimension of each color channel so that the scaled data of each spectrum can be combined into a single RGB image by overlaying each channel and performing circularization of the rectangular overlay image for display on a display device.

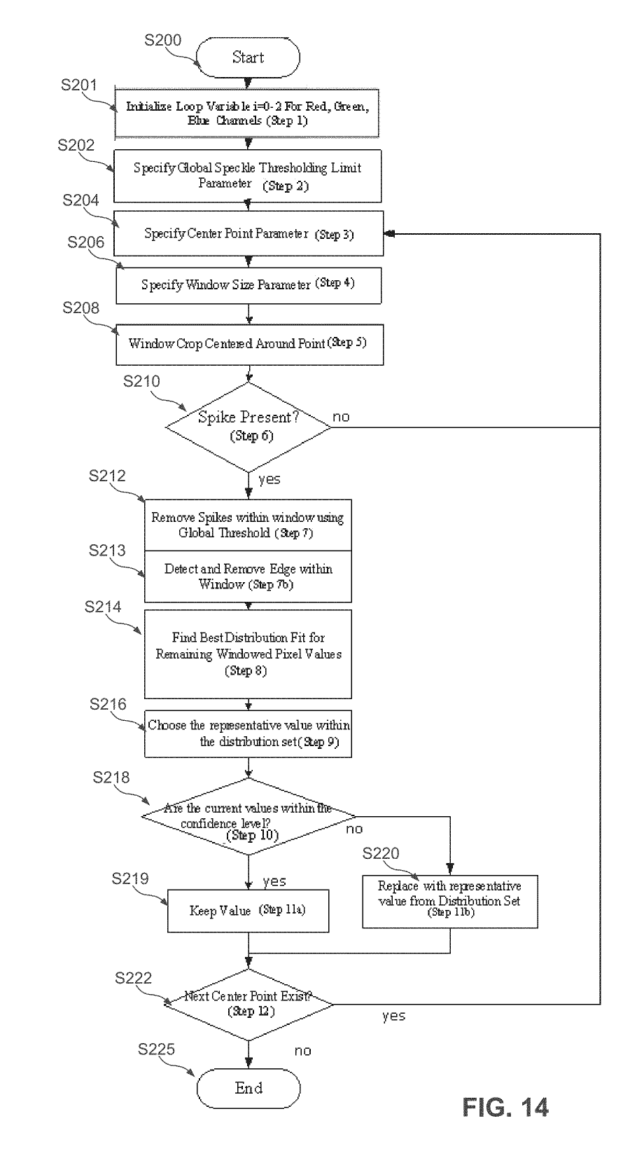

The workflow discussed above that generates a circularized image captured by an exemplary SEE probe system described in FIG. 13 may be adapted to include the speckle correction algorithm discussed herein. An exemplary adaptive of the speckle correction algorithm described above to be included in the workflow used to generate a circularized image of an image surface captured by the SEE probe system is described below in FIG. 14. The algorithm of FIG. 14 may be implemented at any point in the process for generating color images from an image capture apparatus prior to the circularization step due to potential irregularities of speckle size and position within a circularized image that relate specifically to the mechanics of the SEE probe system. Because the probe system rotates about a central point, positions on the probe closer to the center point rotate faster and thus travel a shorter distance than those on the periphery. As such, during the process of circularization which converts an image in the x,y space into an image in the circular space, pixels that may identified as speckle and be of substantially the same size in the x,y space may be appear to be speckle pixels of different sizes. For example, pixels identified as speckle at a position closer to the point about which the probe rotates may be stretched when the image is converted from the x,y space into a circularized image. Thus, the speckle correction algorithm of FIG. 14 and described herein may be performed prior to circularization. In one embodiment, the speckle correction algorithm of FIG. 14 may be implemented by the image processor (of FIG. 13) after generation of a combined RGB image from the scale corrected RGB channels. In another embodiment, the speckle correction algorithm of FIG. 14 may be implemented by the image processor after scale correction and prior to combining the scale corrected data into the combined image. In a further embodiment, the speckle correction algorithm of FIG. 14 may be implemented by the image processor after spectrum compensation and prior to scale correction. The speckle correction algorithm may also be applied on the raw data captured by the SEE probe.

FIG. 14 includes substantially the same algorithmic steps as discussed above with respect to FIG. 7. Thus, the description of FIG. 7 and the processing performed thereby is incporated herein by reference in its entirety and only the processing step that is different from FIG. 7 is described now. This algorithm is used in color processing for identifying pixels that are indicative of speckle data and removing them within the final color image to be output for display. Thus, after the algorithm initiates at S200, the algorithm initiates a loop variable equal to a number of color spectrums for which correction is to be performed. The embodiment shown herein initiates 3 loops, one each for image data in the red spectrum, image data for the green spectrum and image data for the blue spectrum. The result is that the remaining processing steps S202-S222 describe hereinabove with respect to FIG. 7 are performed on a per color channel basis so that pixels in the respective color channel indicative of speckle can be dynamically replaced prior to circularization of the image data which is then output for display on a display device.

In referring to the description, specific details are set forth in order to provide a thorough understanding of the examples disclosed. In other instances, well-known methods, procedures, components, and circuits have not been described in detail as not to unnecessarily lengthen the present disclosure.

It should be understood that if an element or part is referred herein as being “on”, “against”, “connected to”, or “coupled to” another element or part, then it may be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90° or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

The foregoing merely illustrates the principles of the disclosure. Various modifications and alterations to the described exemplary embodiments will be apparent to those skilled in the art in view of the teachings herein. Indeed, the arrangements, systems and methods according to the exemplary embodiments of the present disclosure can be used with any SEE system or other imaging systems.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

We claim,

1. An image processing device that processes image data comprising:
one or more processors; and
one or more memory devices storing instructions that, when executed by the one or more processors, configures the one or more processors to
generate a window having a predetermined size and including a geometric center point to analyze the image data;
identify, as speckle data, one or more pixels of the image data positioned within the generated window; and
generate corrected image data by replacing the one or more pixels identified as speckle data with a replacement pixel value derived from pixels surrounding to the one or more pixels identified as speckle data in a case where the one or more pixels identified as speckle data is equal to or greater than a confidence threshold.

2. The image processing device according to claim 1, wherein the one or more processors are further configured to
identify one or more pixels within the generated window as boundary pixels; and
exclude the boundary pixels from being used in deriving replacement pixel values to be used in replacing the one or more pixels identified as speckle data.

3. The image processing device according to claim 1, wherein the one or more processors are further configured to
maintain pixel values of the one or more pixels identified as speckle data in a case where the one or more pixel values is less than the confidence threshold.

4. The image processing device according to claim 1, wherein the one or more processors are further configured to
move the generated window over the image data;
at each position on the image data that the generated widow is moved,
determine if any additional pixels within the generated window should be identified as speckle data; and
replace any additional pixels determined to be speckle data with the replacement pixel values derived from pixels surrounding each of the additional pixels determined to be speckle data.

5. The image processing device according to claim 1, wherein the one or more processors are configured to identify the one or more pixels within the generated window as speckle data by
generating a histogram of the image data indicating intensity values pixels that form the image data and frequency at which pixels of specific intensities occur;
selecting pixel intensity values that exceed a predetermined intensity value as a global speckle threshold which, when exceeded by one or more pixels within the generated window indicates that the one or more pixels are speckle data.

6. The image processing device according to claim 1, wherein the one or more processors are configured to
determine, using all pixel values from within the generated window, distribution data set from which the replacement pixel value is derived.

7. The image processing device according to claim 6, wherein the distribution data set is distribution curve and when the one or more pixels identified as speckle data are equal to or greater than the confidence value, the one or more processors are further configured to
derive the replacement pixel value by using a random pixel value from the distribution curve.

8. The image processing device according to claim 6, wherein the distribution data set is distribution curve and when the one or more pixels identified as speckle data are equal to or greater than the confidence value, the one or more processors are further configured to
derive the replacement pixel value by generating a mean pixel value from the distribution curve.

9. The image processing device according to claim 6, wherein the distribution data set is distribution curve and when the one or more pixels identified as speckle data are equal to or greater than the confidence value, the one or more processors are further configured to
derive the replacement pixel value by using a median pixel value from the distribution curve.

10. The image processing device according to claim 6, wherein the distribution data set is one of (a) a normalized distribution curve, (b) a multimodal distribution curve, or (c) a skewed distribution curve.

11. The image processing device according to claim 1, wherein the image data is color image data; and the one or more processors
for each color channel of the color image data, identify speckle data and generate corrected image data; and
combine generated corrected image data of each color into an color image to be displayed on a display device.

12. An image processing method comprising:
generating a window having a predetermined size and including a geometric center point to analyze the image data;
identifying, as speckle data, one or more pixels of the image data positioned within the generated window; and
generating corrected image data by replacing the one or more pixels identified as speckle data with a replacement pixel value derived from pixels surrounding to the one or more pixels identified as speckle data in a case where the one or more pixels identified as speckle data is equal to or greater than a confidence threshold.

13. The image processing method according to claim 12, further comprising
identifying one or more pixels within the generated window as boundary pixels; and
excluding the boundary pixels from being used in deriving replacement pixel values to be used in replacing the one or more pixels identified as speckle data.

14. The image processing method according to claim 12, further comprising
maintaining pixel values of the one or more pixels identified as speckle data in a case where the one or more pixel values is less than the confidence threshold.

15. The image processing method according to claim 12, further comprising
moving the generated window over the image data;
at each position on the image data that the generated widow is moved,
determining if any additional pixels within the generated window should be identified as speckle data; and
replacing any additional pixels determined to be speckle data with the replacement pixel values derived from pixels surrounding each of the additional pixels determined to be speckle data.

16. The image processing method according to claim 12, wherein identifying the one or more pixels within the generated window as speckle data includes
generating a histogram of the image data indicating intensity values pixels that form the image data and frequency at which pixels of specific intensities occur;
selecting pixel intensity values that exceed a predetermined intensity value as a global speckle threshold which, when exceeded by one or more pixels within the generated window indicates that the one or more pixels are speckle data.

17. The image processing method according to claim 12, further comprising
determining, using all pixel values from within the generated window, distribution data set from which the replacement pixel value is derived.

18. The image processing method according to claim 17, wherein the distribution data set is distribution curve and when the one or more pixels identified as speckle data are equal to or greater than the confidence value, and further comprising
deriving the replacement pixel value by using a random pixel value from the distribution curve.

19. The image processing method according to claim 17, wherein the distribution data set is distribution curve and when the one or more pixels identified as speckle data are equal to or greater than the confidence value, and further comprising
deriving the replacement pixel value by generating a mean pixel value from the distribution curve.

20. The image processing method according to claim 17, wherein the distribution data set is distribution curve and when the one or more pixels identified as speckle data are equal to or greater than the confidence value, and further comprising
deriving the replacement pixel value by using a median pixel value from the distribution curve.

21. The image processing method according to claim 17, wherein the distribution data set is one of (a) a normalized distribution curve, (b) a multimodal distribution curve, or (c) a skewed distribution curve.

22. The image processing method according to claim 12, wherein the image data is color image data; and further comprising
for each color channel of the color image data, identifying speckle data and generating corrected image data; and
combining generated corrected image data of each color into an color image to be displayed on a display device.
